(19) United States
(12) Patent Application Publication
(10) Pub. No.: US 2026/0251574 A1
(43) Pub. Date: Aug. 27, 2026

(54) SAMPLE MEASUREMENT DEVICE AND SAMPLE MEASUREMENT METHOD

(71) Applicant: HAMAMATSU PHOTONICS K.K., Hamamatsu-shi, Shizuoka (JP)

(72) Inventors: Kazuhiko FUJIWARA, Hamamatsu-shi, Shizuoka (JP); Yoshihiro MARUYAMA, Hamamatsu-shi, Shizuoka (JP)

(73) Assignee: HAMAMATSU PHOTONICS K.K., Hamamatsu-shi, Shizuoka (JP)

(21) Appl. No.: 18/845,457

(22) PCT Filed: Feb. 9, 2023
(86) PCT No.: PCT/JP2023/004441

§ 371 Date: Sep. 10, 2024

(30) Foreign Application Priority Data
Mar. 16, 2022 (JP) 2022-041127

(51) Int. Cl. G01N 21/65

(52) U.S. Cl. CPC G01N 21/65; G01N 2201/105

(57) ABSTRACT

An irradiation unit scans an excitation light irradiation position along a line which does not pass through a same position a plurality of times in a measurement range on a sample over a period in which a measurement unit acquires one Raman spectrum. In the case in which a plurality of scanning lines are used, it is set such that each scanning line does not pass through the same position on the sample a plurality of times. It is set such that the plurality of scanning lines do not pass through the same position a plurality of times. Further, it is set such that a plurality of excitation light irradiation regions do not overlap each other.

### TECHNICAL FIELD

The present disclosure relates to a sample measurement apparatus and a sample measurement method for analyzing a sample by using Raman spectroscopy.

### BACKGROUND ART

When a sample is irradiated with light, Raman scattered light having a wavelength different from a wavelength of the irradiation light is generated in the sample due to the Raman effect. A relationship of an intensity of the Raman scattered light with respect to a difference between a wavenumber of the Raman scattered light and a wavenumber of the irradiation light (a Raman spectrum) corresponds to a molecular structure, a crystal structure, components, and the like of the sample. In Raman spectroscopy, analysis of the sample can be performed based on the above Raman spectrum.

In one configuration example of a sample measurement apparatus for analyzing the sample by using the Raman spectroscopy, the sample is irradiated with monochromatic laser light output from a laser light source as excitation light, and a spectrum of the Raman scattered light generated in the sample in response to the excitation light irradiation is measured by using a spectrometer. A focusing optical system is provided between the laser light source and the sample to focus the excitation light and irradiate a limited irradiation region on the sample with the excitation light.

An imaging optical system is provided between the sample and the spectrometer such that an excitation light irradiation position on the sample and a position of a slit (a slit through which the Raman scattered light passes) of the spectrometer have an optically conjugate positional relationship with each other. A width of the slit of the spectrometer is set to several μm to several tens of μm. A diameter of an excitation light irradiation region on the sample is set to several tens of μm at most. In this case, the sample can be analyzed with high spatial resolution.

By using the sample measurement apparatus having the configuration described above, the analysis of the sample called mapping can be performed. In the above analysis method, a plurality of excitation light irradiation positions are set on the sample, and the Raman spectrum is acquired for a limited excitation light irradiation region around each of the excitation light irradiation positions, and thus, a map of the Raman spectrum on the sample is created. In this case, a localization and a distribution of a specific material in the sample can be analyzed. The above analysis method by using the mapping can be effective in the case of analyzing the distribution of an active ingredient in the sample of a solid mixture such as, for example, a solid drug formulation.

However, on the other hand, in the analysis method by using the mapping, when a non-uniform solid sample is analyzed, it is not possible to determine which component the Raman spectrum acquired for each of the excitation light irradiation positions is due to (for example, which of an active ingredient, an additional excipient, a mixture of these, and the like the Raman spectrum is due to), and thus, it is difficult to perform quantitative determination of a component in the solid sample or perform analysis of a component ratio.

In the sample measurement technique described in Patent Document 1, the excitation light irradiation position is scanned in a predetermined measurement range on the sample, and one Raman spectrum is acquired based on the Raman scattered light generated over a period of the above scanning.

As compared with the case of measuring the spectrum of the Raman scattered light generated in the limited excitation light irradiation region (with a diameter of several tens of μm) around the one excitation light irradiation position on the sample, in the sample measurement technique described in Patent Document 1, it is possible to acquire an integrated value or an average value of the spectrum of the Raman scattered light generated over the period of the scanning of the excitation light irradiation position in a wider measurement range. Therefore, in the above technique, for example, even in the case of analyzing the non-uniform solid sample, it is considered that the quantitative determination of the component or the analysis of the component ratio in the measurement range of the solid sample can be performed.

### Citation List

### Patent Literature

Patent Document 1: US Patent Application Publication No. 2012/0162642

### SUMMARY OF INVENTION

### Technical Problem

However, in the sample measurement technique described in Patent Document 1, the excitation light irradiation position is scanned along a line having a complicated shape in the measurement range on the sample, and thus, a certain position in the measurement range may be irradiated with the excitation light a plurality of times, and on the other hand, another certain position in the measurement range may not be irradiated with the excitation light, and accordingly, a length of time in which it is irradiated with the excitation light may be different depending on the position in the measurement range. As a result, for example, in the case in which the non-uniform solid sample is analyzed, the acquired Raman spectrum does not indicate the average of the component amount or the like in the measurement range, and it is difficult to perform quantitative analysis.

An object of the present invention is to provide a sample measurement apparatus and a sample measurement method capable of easily performing quantitative analysis by using Raman spectroscopy in a measurement range on a sample.

### Solution to Problem

An embodiment of the present invention is a sample measurement apparatus. The sample measurement apparatus is a sample measurement apparatus for analyzing a sample by using Raman spectroscopy, and includes an irradiation unit for irradiating the sample with excitation light output from a light source; and a measurement unit for receiving Raman scattered light generated in the sample in response to irradiation of the excitation light, and acquiring a Raman spectrum, and the irradiation unit scans an excitation light irradiation position along a line which does not pass through a same position on the sample a plurality of times over a period in which the measurement unit acquires one Raman spectrum.

An embodiment of the present invention is a sample measurement method. The sample measurement method is a sample measurement method for analyzing a sample by using Raman spectroscopy, and includes an irradiation step of irradiating the sample with excitation light output from a light source; and a measurement step of receiving Raman scattered light generated in the sample in response to irradiation of the excitation light, and acquiring a Raman spectrum, and in the irradiation step, an excitation light irradiation position is scanned along a line which does not pass through a same position on the sample a plurality of times over a period in which one Raman spectrum is acquired in the measurement step.

### Advantageous Effects of Invention

According to the embodiments of the present invention, it is possible to easily perform quantitative analysis by using Raman spectroscopy in a measurement range on a sample.

### BRIEF DESCRIPTION OF DRAWINGS

FIG. 1 is a diagram illustrating a configuration of a sample measurement apparatus 1.

FIG. 2 is a diagram illustrating a configuration of a sample measurement apparatus 2.

FIG. 3 is a diagram illustrating scanning of an excitation light irradiation position on a sample 30 by an irradiation unit.

FIG. 4 is a diagram illustrating the scanning of the excitation light irradiation position on the sample 30 by the irradiation unit.

FIG. 5 is a diagram illustrating the scanning of the excitation light irradiation position on the sample 30 by the irradiation unit.

FIG. 6 is a diagram showing a Raman spectrum acquired for a tablet sample in which an acetaminophen content rate is set to each value of 0% and 1.5% in a first example.

FIG. 7 is a diagram showing a spectrum obtained by performing standardization processing on the Raman spectrum shown in FIG. 6 in the first example.

FIG. 8 is a diagram showing a calibration line obtained based on training data in the first example.

FIG. 9 is a diagram showing a Raman spectrum acquired in the case in which the excitation light irradiation position is scanned along one scanning line for the one tablet sample with the acetaminophen content rate of 1.5% in the first example.

FIG. 10 is a diagram showing a loading spectrum obtained by performing principal component analysis in the first example.

FIG. 11 is a diagram showing an average Raman spectrum acquired for a tablet sample in which a coating agent ratio is set to each value of 0.5% and 10% in a second example.

FIG. 12 is a diagram showing a calibration line obtained based on training data in the second example.

### DESCRIPTION OF EMBODIMENTS

Hereinafter, embodiments of a sample measurement apparatus and a sample measurement method will be described in detail with reference to the accompanying drawings. In the description of the drawings, the same elements will be denoted by the same reference signs, and redundant description will be omitted. The present invention is not limited to these examples.

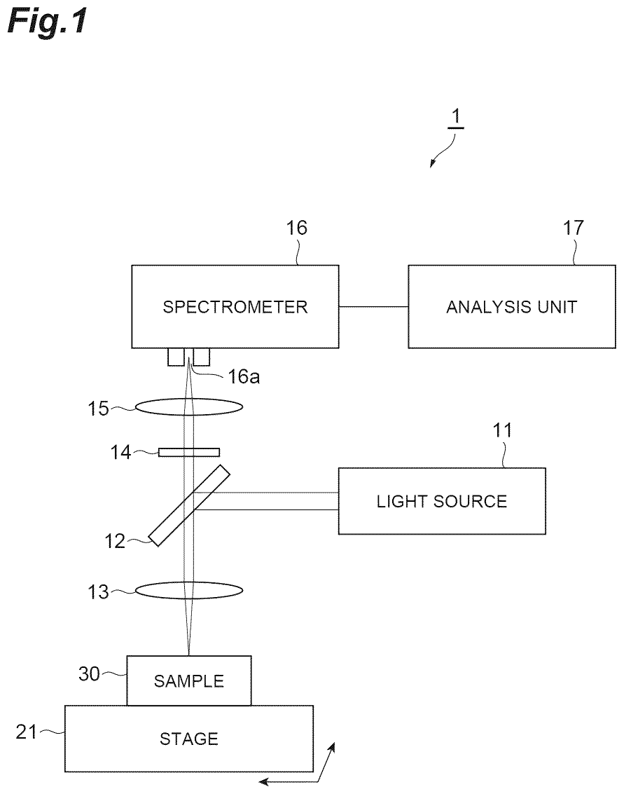

FIG. 1 is a diagram illustrating a configuration of a sample measurement apparatus 1. The sample measurement apparatus 1 includes a light source 11, a dichroic mirror 12, a lens 13, a filter 14, a lens 15, a spectrometer 16, an analysis unit 17, and a stage 21. The sample measurement apparatus 1 analyzes a sample 30 placed on the stage 21 by using the Raman spectroscopy.

The light source 11 outputs excitation light with which the sample 30 is to be irradiated. The light source 11 is preferably a laser light source. The dichroic mirror 12 is optically coupled to the light source 11, and reflects the excitation light output from the light source 11 to the sample 30. Further, the dichroic mirror 12 transmits Raman scattered light which is generated in the sample 30 and reaches the dichroic mirror 12 to the filter 14.

The lens 13 is provided on an optical path between the dichroic mirror 12 and the sample 30. The lens 13 focuses the excitation light arriving from the dichroic mirror 12 on the sample 30 and irradiates the sample 30 with the excitation light. Further, the lens 13 inputs the Raman scattered light generated in the sample 30 in response to the irradiation of the excitation light, and outputs the Raman scattered light to the dichroic mirror 12.

The filter 14 is optically coupled to the dichroic mirror 12, and inputs the light arriving from the sample 30 through the lens 13 and the dichroic mirror 12. The filter 14 selectively blocks reflected light or scattered light of the excitation light included in the input light, and selectively transmits the Raman scattered light to the lens 15. The filter 14 may be a notch filter.

The lens 15 is optically coupled to the filter 14, inputs the Raman scattered light transmitted through and arriving from the filter 14, focuses the Raman scattered light, and inputs the Raman scattered light to a slit 16a of the spectrometer 16. The spectrometer 16 includes the slit 16a, a dispersive element, and a light receiving element array. The spectrometer 16 disperses the Raman scattered light that has passed through the slit 16a by the dispersive element, receives the light of each wavelength component after the dispersion by the light receiving element array, and detects an intensity of the light of each wavelength component. The spectrometer 16 outputs an electrical signal indicating the intensity of the light of each wavelength component detected as described above to the analysis unit 17. The electrical signal indicates a spectrum of the Raman scattered light.

The analysis unit 17 is electrically connected to the spectrometer 16, and inputs the electrical signal output from the spectrometer 16. The analysis unit 17 acquires the Raman spectrum based on the input electrical signal. In addition, the analysis unit 17 performs analysis of the sample 30 based on the above Raman spectrum. The analysis unit 17 may be a computer.

The stage 21 mounts the sample 30 thereon, and can move the sample 30 in a direction perpendicular to an optical axis of the lens 13. By the above movement, it is possible to scan an excitation light irradiation position on the sample 30.

An optical system of the excitation light from the light source 11 to the sample 30 through the dichroic mirror 12 and the lens 13 constitutes a focusing optical system for focusing the excitation light output from the light source 11 on a limited irradiation region on the sample 30 and irradiating the sample 30 with the excitation light. An optical system of the Raman scattered light from the sample 30 to the slit 16a of the spectrometer 16 through the lens 13, the dichroic mirror 12, the filter 14, and the lens 15 constitutes an imaging optical system which is provided such that the excitation light irradiation position on the sample 30 and the position of the slit 16a have an optically conjugate positional relationship with each other.

The light source 11, the dichroic mirror 12, the lens 13, and the stage 21 constitute an irradiation unit for irradiating the sample 30 with the excitation light, and in addition, scanning the excitation light irradiation position. The lens 13, the dichroic mirror 12, the filter 14, the lens 15, the spectrometer 16, and the analysis unit 17 constitute a measurement unit for receiving the Raman scattered light and acquiring the Raman spectrum.

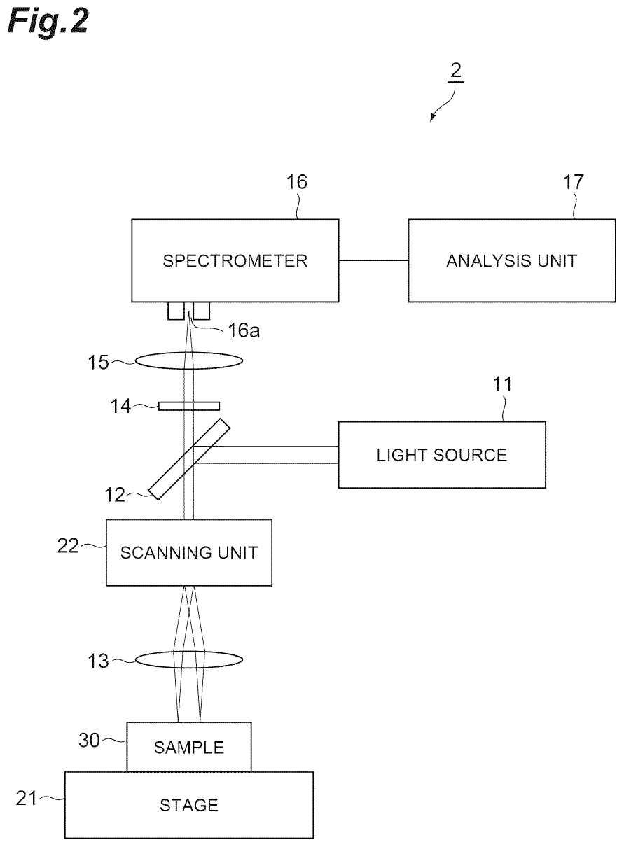

FIG. 2 is a diagram illustrating a configuration of a sample measurement apparatus 2. The sample measurement apparatus 2 includes the light source 11, the dichroic mirror 12, the lens 13, the filter 14, the lens 15, the spectrometer 16, the analysis unit 17, the stage 21, and a scanning unit 22. The sample measurement apparatus 2 analyzes the sample 30 placed on the stage 21 by using the Raman spectroscopy.

As compared with the configuration of the sample measurement apparatus 1 illustrated in FIG. 1, the sample measurement apparatus 2 illustrated in FIG. 2 is different in that it further includes the scanning unit 22. The stage 21 provided in the sample measurement apparatus 2 may not move the sample 30 in the direction perpendicular to the optical axis of the lens 13.

The scanning unit 22 is provided on an optical path between the dichroic mirror 12 and the lens 13. The scanning unit 22 inputs the excitation light arriving from the dichroic mirror 12, and outputs the excitation light to the lens 13. The scanning unit 22 can change a light output direction when the excitation light is output to the lens 13. By the above change of the light output direction, it is possible to scan the excitation light irradiation position on the sample 30. The scanning unit 22 may have a configuration including, for example, a galvano mirror or a polygon mirror.

An optical system of the excitation light from the light source 11 to the sample 30 through the dichroic mirror 12, the scanning unit 22, and the lens 13 constitutes the focusing optical system for focusing the excitation light output from the light source 11 on the limited irradiation region on the sample 30 and irradiating the sample 30 with the excitation light. An optical system of the Raman scattered light from the sample 30 to the slit 16a of the spectrometer 16 through the lens 13, the scanning unit 22, the dichroic mirror 12, the filter 14, and the lens 15 constitutes the imaging optical system which is provided such that the excitation light irradiation position on the sample 30 and the position of the slit 16a have an optically conjugate positional relationship with each other.

The light source 11, the dichroic mirror 12, the scanning unit 22, and the lens 13 constitute the irradiation unit for irradiating the sample 30 with the excitation light, and in addition, scanning the excitation light irradiation position. The lens 13, the scanning unit 22, the dichroic mirror 12, the filter 14, the lens 15, the spectrometer 16, and the analysis unit 17 constitute the measurement unit for receiving the Raman scattered light and acquiring the Raman spectrum.

Each of the sample measurement apparatus 1 (FIG. 1) and the sample measurement apparatus 2 (FIG. 2) performs the scanning of the excitation light irradiation position on the sample 30 by the irradiation unit and the acquisition of the Raman spectrum by the measurement unit in association with each other.

That is, the irradiation unit scans the excitation light irradiation position along a line which does not pass through the same position on the sample 30 a plurality of times over a period in which the measurement unit acquires one Raman spectrum. In other words, over a certain period, the irradiation unit scans the excitation light irradiation position along the line which does not pass through the same position on the sample 30 a plurality of times, and further, the measurement unit acquires the one Raman spectrum. Thus, it is possible to easily perform quantitative analysis by using the Raman spectroscopy in the measurement range on the sample 30.

The condition that the scanning line does not pass through the same position on the sample 30 a plurality of times includes not only that the scanning line does not intersect itself at a certain position, but also that a certain range of the scanning line and another certain range do not overlap each other. The excitation light irradiation position may be scanned only once along the scanning line, or may be scanned a plurality of times.

Further, the acquisition of the one Raman spectrum by the measurement unit over the certain period includes not only the acquisition of the one Raman spectrum by continuously exposing the light receiving element array of the spectrometer 16 over the period, but also the acquisition of the one Raman spectrum by dividing the period into a plurality of partial periods, and obtaining a sum of spectra detected by the light receiving element array respectively in the partial periods.

A sample measurement method according to the present embodiment is a method for analyzing the sample 30 by using the Raman spectroscopy, and can be performed by using the sample measurement apparatus 1 (FIG. 1) or the sample measurement apparatus 2 (FIG. 2). The sample measurement method of the present embodiment includes an irradiation step and a measurement step.

The irradiation step is a process performed by the irradiation unit of the sample measurement apparatus 1 or the sample measurement apparatus 2, and irradiates the sample 30 with the excitation light output from the light source 11. The measurement step is a process performed by the measurement unit of the sample measurement apparatus 1 or the sample measurement apparatus 2, and acquires the Raman spectrum by receiving the Raman scattered light generated in the sample 30 in response to the irradiation of the excitation light. In the irradiation step, the excitation light irradiation position is scanned along the line which does not pass through the same position on the sample 30 a plurality of times over the period in which the one Raman spectrum is acquired in the measurement step. The respective processes of the irradiation step and the measurement step are performed in a common period.

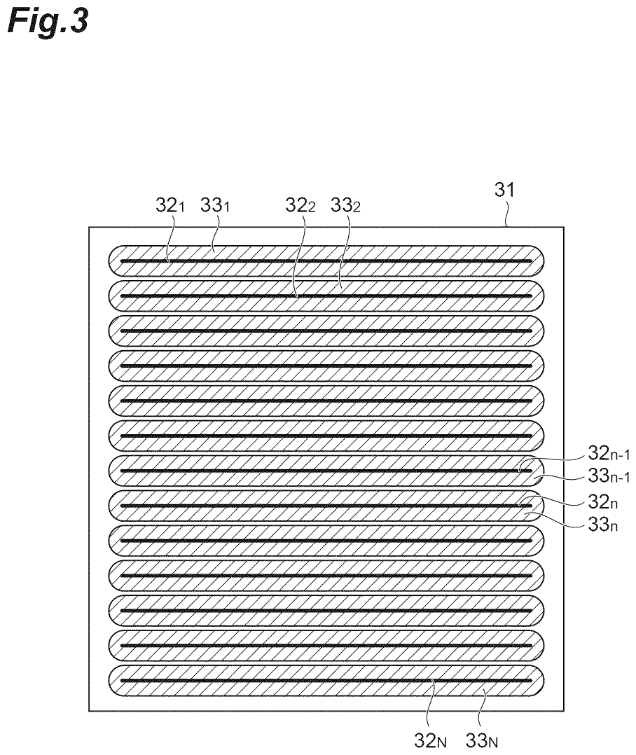

FIG. 3 to FIG. 5 are diagrams each illustrating the scanning of the excitation light irradiation position on the sample 30 performed by the irradiation unit.

In FIG. 3, in a measurement range 31 on the sample 30, an excitation light irradiation region 33ₙ around each scanning line 32n is illustrated by hatching in the case in which the excitation light irradiation position is scanned along each of N scanning lines 32₁ to 32_{N}. N may be 1, or may be an integer of 2 or more. n is an integer of 1 or more and N or less. In this example, the one Raman spectrum can be acquired for each excitation light irradiation region 33ₙ.

In the case in which the excitation light irradiation position is sequentially scanned along each of the N scanning lines 32₁ to 32_{N}, for example, the excitation light irradiation position may be scanned in a right direction in an odd-numbered scanning line, and the excitation light irradiation position may be scanned in a left direction in an even-numbered scanning line. In this case, at the time of transition from the scanning end of the certain scanning line 32ₙ₋₁ to the scanning start of the next scanning line 32ₙ, a movement distance can be shortened, and a time required for the above process can be shortened.

The measurement range 31 is a range on the sample 30 to be analyzed by using the Raman scattering spectroscopy. The excitation light irradiation position is a peak intensity position of the excitation light on which the focused irradiation is performed on the sample 30 by using the lens 13. In the case in which there are a plurality of peak intensity positions, any one of the peak intensity positions may be set as the excitation light irradiation position. Further, in the case in which there is no clear peak intensity position, a range having an intensity close to a peak intensity (for example, an intensity of 90% or more of the peak intensity) may be regarded as the excitation light irradiation position.

The excitation light irradiation region 33n is a region on which the irradiation of the excitation light is performed when the excitation light irradiation position is scanned along the scanning line 32ₙ, and is a region in which the Raman scattered light can be significantly generated by the excitation light irradiation.

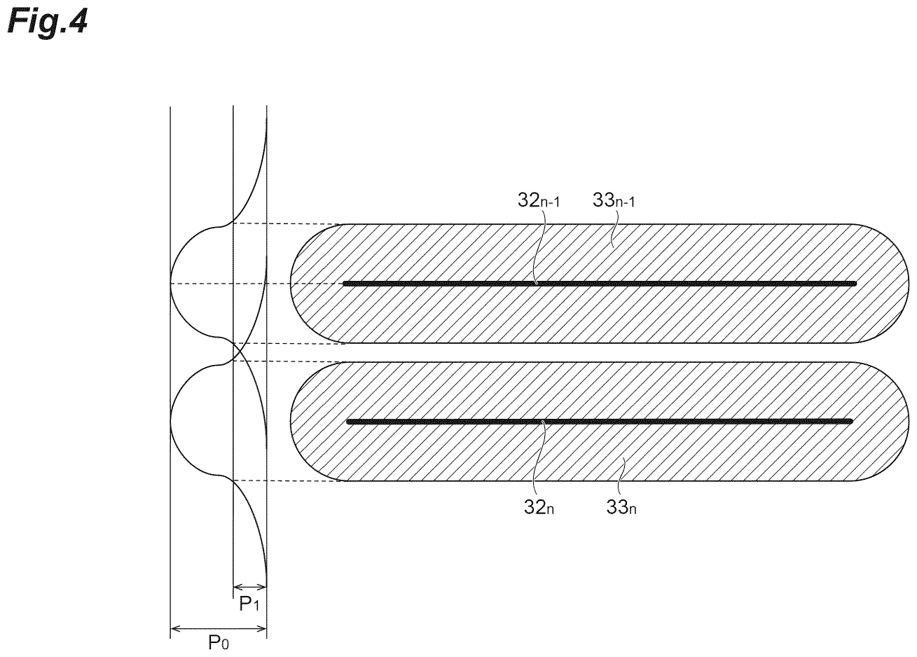

In FIG. 4, the excitation light irradiation regions 33ₙ₋₁ and 33ₙ respectively around the arbitrary two adjacent scanning lines 32ₙ₋₁ and 32ₙ out of the N scanning lines 32₁ to 32_{N} are illustrated by hatching, and further, an excitation light irradiation intensity distribution in a direction perpendicular to the scanning line is illustrated. As illustrated in this diagram, the excitation light irradiation region 331 may be set to a region which is irradiated with the excitation light having an intensity equal to or larger than an intensity P₁ of a predetermined ratio with respect to the peak intensity P₀ of the excitation light on the scanning line 32ₙ. In this case, the predetermined ratio (P₁/P₀) may be set to, for example, ½ or 1/e, or may be set to another value.

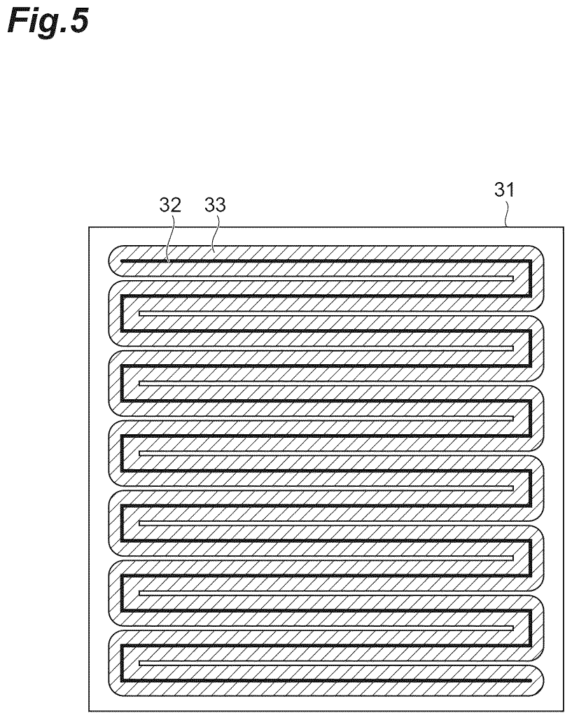

In FIG. 5, the case in which one scanning line 32 is bent in the measurement range 31 is illustrated. As illustrated in this diagram, the one scanning line 32 repeats bending, and thus, an excitation light irradiation region 33 (a hatched region) when the excitation light irradiation position is scanned along the one scanning line 32 can occupy a wide portion in the measurement range 31. In this example, the one Raman spectrum can be acquired for the measurement range 31.

The shape and the number of the scanning lines are arbitrary, and accordingly, the shape and the number of the excitation light irradiation regions are also arbitrary. In addition, the scanning line is preferably a line having a straight line shape. By setting the scanning line to have the straight line shape, it is easy to perform the scanning of the excitation light irradiation position by the stage 21 or the scanning unit 22.

Further, as illustrated in FIG. 3, in the case in which the scanning line is set to the plurality of scanning lines 32₁ to 32_{N}, by setting each scanning line 32ₙ to have the straight line shape, it is easy to arrange the plurality of excitation light irradiation regions 33₁ to 33_{N} in parallel in the measurement range 31, and further, it is possible to perform the Raman spectroscopy for each excitation light irradiation region 33ₙ in a wide portion in the measurement range 31. Further, it is preferable that the excitation light irradiation position is scanned at a constant speed along each scanning line 32ₙ. In this case, the quantitative analysis with high accuracy can be performed by using the Raman spectroscopy.

As illustrated in FIG. 3, in the case in which the scanning line is set to the plurality of scanning lines 32₁ to 32_{N}, it is preferable that each scanning line 32ₙ does not pass through the same position on the sample 30 a plurality of times. Further, it is also preferable that it does not pass through the same position or the same range a plurality of times in the scanning along the plurality of scanning lines 32₁ to 32_{N}. In addition, it is also preferable that the plurality of excitation light irradiation regions 33₁ to 33_{N} do not overlap each other.

When performing the analysis of the sample 30 based on the Raman spectrum, it is preferable that the analysis unit 17 performs standardization processing on the Raman spectrum, and performs the analysis of the sample 30 based on the Raman spectrum after the above processing. The standardization processing is processing in which a deviation of data from an average value is divided by a standard deviation to convert the data into data having the average value of 0 and the standard deviation of 1.

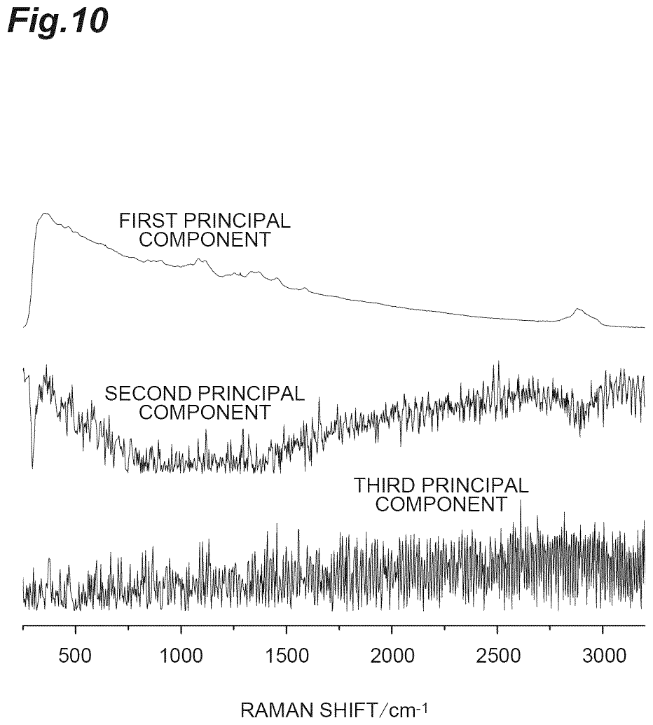

It is also preferable that the analysis unit 17 extracts a feature of the Raman spectrum by using machine learning, and performs the analysis of the sample 30 based on the feature. The feature indicates a component (some or a single component in a plurality of components) in the sample found from the Raman spectrum, or a spectral component separated in calculation (for example, a signal and a noise, each of which is the feature, as can be confirmed in FIG. 10).

Next, first and second examples will be described. In each of the first and second examples, the sample measurement apparatus 1 having the configuration illustrated in FIG. 1 was used, and the excitation light irradiation position on the sample was scanned with each scanning line set to the line having the straight line shape as illustrated in FIG. 3. A laser diode for outputting laser light having a wavelength of 785 nm as the excitation light was used as the light source 11. An objective lens having a magnification of 5 times was used as the lens 13. A spectrometer including a cooled CCD detector was used as the spectrometer 16. A beam diameter (full width at half maximum) of the excitation light on the sample was set to 25 μm.

In the first example, as the sample of the analysis object, a tablet sample containing acetaminophen with a predetermined ratio of corn starch and lactose as excipients was prepared. A content rate of acetaminophen was set to four types of 0, 0.5, 1.0, and 1.5% (w/w), and tablet samples of ten tablets were prepared for each of the content rates. A diameter of each of the tablet samples was set to about 8 mm.

In the measurement range having a rectangular shape of four sides of 4.5 mm at a center portion in the 8 mm diameter, 180 scanning lines each having a straight line shape with a constant length (about 4.5 mm) were set in parallel at a constant pitch (25 μm). The excitation light irradiation position was scanned at a constant speed (4.5 mm/sec) along each of the scanning lines. The one Raman spectrum was acquired for each of the scanning lines. That is, 180 Raman spectra were acquired for each of the tablet samples. A power of the excitation light on the sample was set to 7 mW.

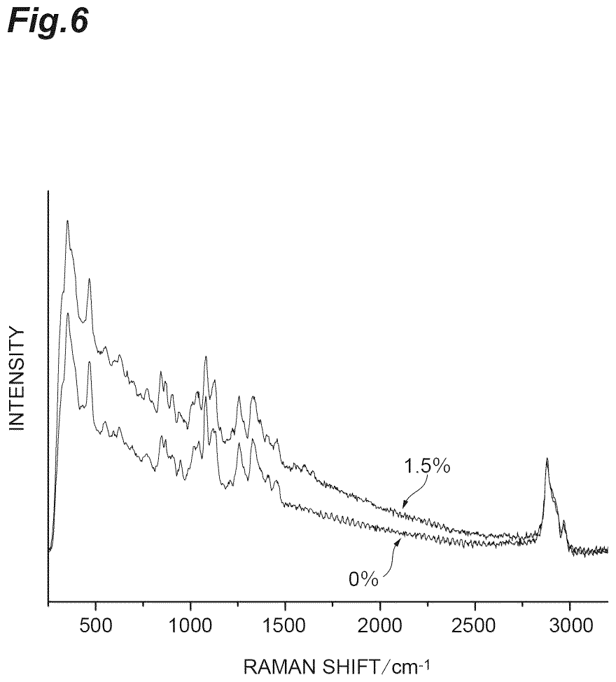

FIG. 6 is a diagram showing the Raman spectrum acquired for the tablet sample in which the acetaminophen content rate is set to each value of 0% and 1.5% in the first example. Each of the Raman spectra shown in this diagram is an average of the 180 Raman spectra acquired for the one tablet sample.

As shown in this diagram, when the acetaminophen content rate is set to be different, the intensity of the Raman scattered light is also different. However, a shape obtained by multiplying the one Raman spectrum by a constant is close to a shape of the other Raman spectrum, and thus, it is difficult to determine whether a difference of the shapes of the Raman spectra is caused by a difference in the acetaminophen content rate or a change in the excitation light intensity.

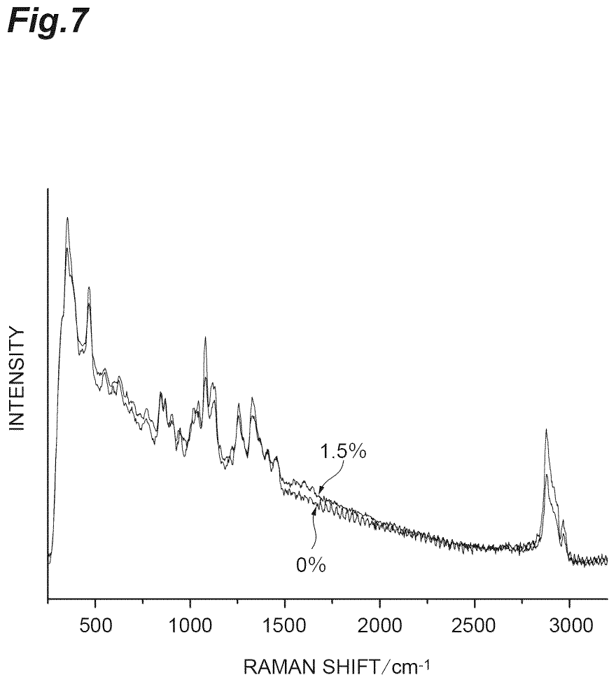

FIG. 7 is a diagram showing the Raman spectrum obtained by performing the standardization processing on the Raman spectrum shown in FIG. 6 in the first example. As shown in this diagram, the Raman spectra after performing the standardization processing have substantially the same shape as a whole regardless of the acetaminophen content rate, and on the other hand, the peak intensity increases as the acetaminophen content rate increases. Therefore, the acetaminophen content rate can be measured based on the peak intensity in the Raman spectrum after the standardization processing.

The calibration was performed with respect to the acetaminophen content rate by using partial least squares regression (PLS). In this calibration, for each of the four types of the acetaminophen content rates, the Raman spectra after performing the standardization processing of the tablet samples of five tablets out of the ten tablets were used as training data, and the Raman spectra after performing the standardization processing of the tablet samples of the other five tablets were used as evaluation data.

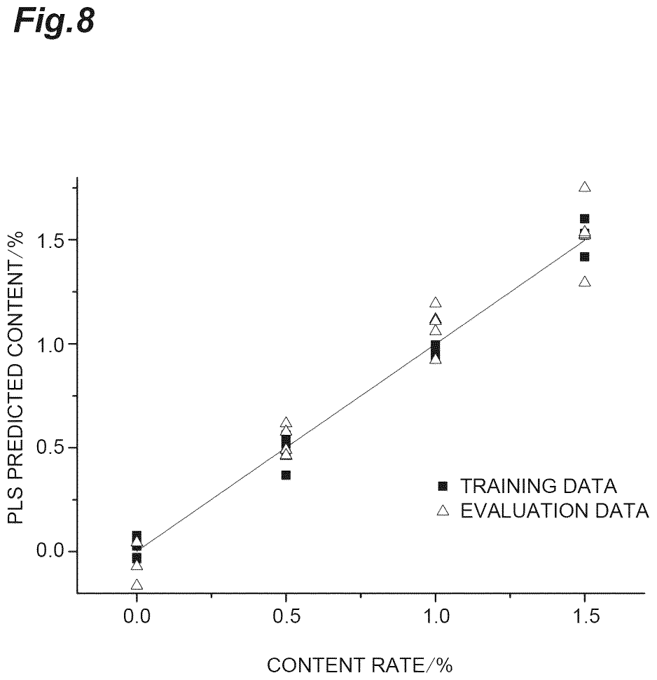

FIG. 8 is a diagram showing a calibration line obtained based on the training data in the first example. The horizontal axis indicates the actual acetaminophen content rate, and the vertical axis indicates the PLS predicted content. A correlation coefficient for the evaluation data is 0.9952, and a least squares error is 0.055. It is confirmed that there is a good correlation between the actual acetaminophen content rate and the PLS predicted content rate.

It is also possible to perform feature extraction by using multivariate analysis using the 180 Raman spectra acquired for each of the tablet samples. In this case, principal component analysis was performed as the multivariate analysis.

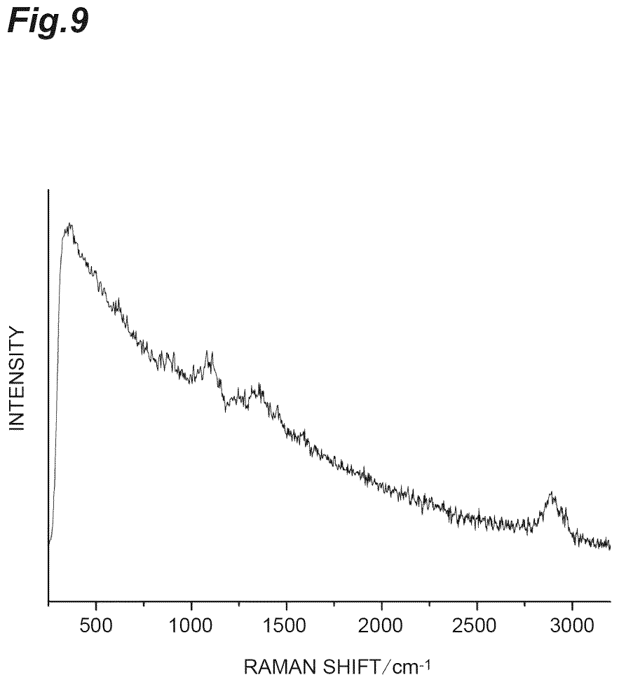

FIG. 9 is a diagram showing the Raman spectrum acquired in the case in which the excitation light irradiation position is scanned along the one scanning line for the one tablet sample with the acetaminophen content rate of 1.5% in the first example. For each of the tablet samples, 180 Raman spectra as described above were acquired. The principal component analysis was performed for the 180 Raman spectra.

FIG. 10 is a diagram showing a loading spectrum obtained by performing the principal component analysis in the first example. From an eigenvector, a ratio of a first principal component is 98.8%. Components below a second principal component are determined to be mostly noise.

In the second example, as the sample of the analysis object, a tablet sample obtained by coating a plain tablet having the same size as that in the first example was prepared. A coating liquid was prepared by adding hypromellose, polyethylene glycol (molecular weight of about 6000), talc, and food yellow No. 5 to purified water at predetermined ratios.

The coating liquid was applied to the plain tablet by using an airflow type tablet coating apparatus (manufactured by Freund Corporation). A content ratio of the coating agent with respect to the plain tablet in the tablet sample after drying and solidification was varied in the range of 0 to 10.0% (w/w) by controlling an amount of the coating liquid which was applied to the plain tablet. A power of the excitation light on the sample was set to 12.4 mW.

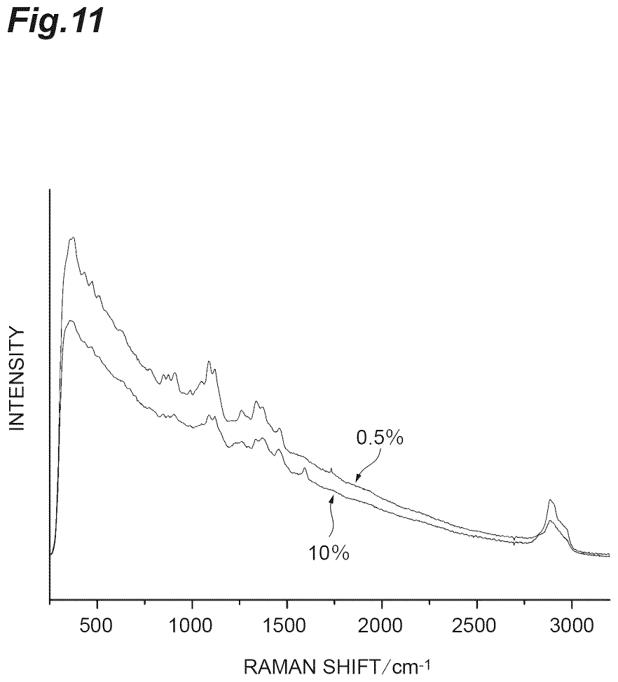

Raman spectra were acquired for five tablet samples for each coating agent ratio. FIG. 11 is a diagram showing the average Raman spectrum acquired for the tablet sample in which the coating agent ratio is set to each value of 0.5% and 10% in the second example. As shown in this diagram, when the coating agent ratio is set to be different, the intensity of the Raman scattered light is also different.

The calibration was performed with respect to the coating agent ratio by using the PLS. In this calibration, for each of the coating agent ratios, the Raman spectra of the tablet samples of three tablets out of the five tablets were used as training data, and the Raman spectra of the tablet samples of the other two tablets were used as evaluation data. A tablet sample prepared according to the same formulation was dissolved in water, and the coating amount was quantified by using absorption photometry, and an obtained value was used as a true value of the coating amount.

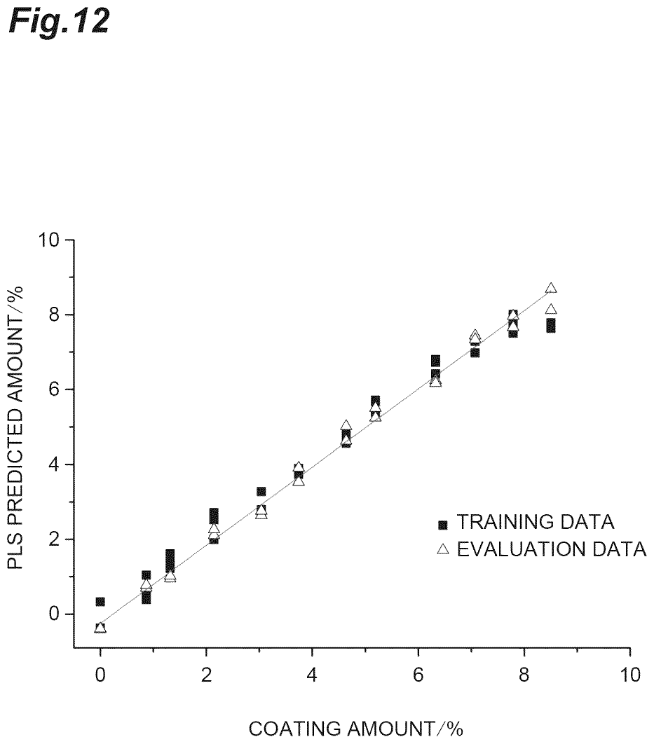

FIG. 12 is a diagram showing a calibration line obtained based on the training data in the second example. The horizontal axis indicates the coating amount of the true value, and the vertical axis indicates the PLS predicted amount. A correlation coefficient for the evaluation data is 0.9954, and a least squares error is 0.2579. It is confirmed that there is a good correlation between the coating amount of the true value and the PLS predicted rate.

According to the present embodiment, it is possible to easily perform the quantitative analysis by using the Raman spectroscopy in the measurement range on the sample. By scanning the excitation light irradiation position along the line which does not pass through the same position on the sample a plurality of times over a period for acquiring the one Raman spectrum, the quantitative analysis can be performed for a wide measurement range.

By providing the plurality of excitation light irradiation regions in the measurement range, it is possible to perform the feature extraction by using the principal component analysis or the like. Further, by providing the plurality of excitation light irradiation regions in the measurement range, it is possible to perform rapid foreign material inspection or the like in the case of the uniform sample.

In recent years, in the pharmaceutical and formulation field, establishment of a manufacturing method called continuous production in which a plurality of manufacturing processes are continuously performed has been promoted mainly by regulatory authorities of respective countries for the main purpose of eliminating human errors and improving safety of products. This requires automation of the inspection process as the manufacturing processes are continuously performed. In particular, a technique for performing inspection and monitoring is referred to as process analytical technology (PAT).

In the manufacturing process of drug formulation, measurement of chemical amount is required in many cases, such as content monitoring, monitoring of mixing end point, water amount, and coating amount, and the like. The spectroscopic measurement is effective for the in-line or on-line chemical measurement described above, and further, the Raman spectroscopy is promising as one of the PAT tools used for the chemical measurement. In the above situation, the sample measurement apparatus or the sample measurement method of the present embodiment can be effectively used.

The sample measurement apparatus and the sample measurement method are not limited to the embodiments and configuration examples described above, and can be modified in various ways.

The sample measurement apparatus according to the above embodiment is a sample measurement apparatus for analyzing a sample by using Raman spectroscopy, and includes an irradiation unit for irradiating the sample with excitation light output from a light source; and a measurement unit for receiving Raman scattered light generated in the sample in response to irradiation of the excitation light, and acquiring a Raman spectrum, and the irradiation unit scans an excitation light irradiation position along a line which does not pass through a same position on the sample a plurality of times over a period in which the measurement unit acquires one Raman spectrum.

In the above sample measurement apparatus, the irradiation unit may scan the excitation light irradiation position along the line having a straight line shape. Further, the irradiation unit may scan the excitation light irradiation position along the line at a constant speed.

In the above sample measurement apparatus, the irradiation unit may scan the excitation light irradiation position along each of a plurality of lines, and each line does not pass through the same position on the sample a plurality of times, and the measurement unit may acquire the one Raman spectrum for each of the plurality of lines.

In the above sample measurement apparatus, the irradiation unit may scan the excitation light irradiation position such that it does not pass through the same position on the sample in scanning of the excitation light irradiation position along the plurality of lines on the sample. Further, the irradiation unit may scan the excitation light irradiation position such that excitation light irradiation regions on the sample in scanning of the excitation light irradiation position along the plurality of lines on the sample do not overlap each other.

In the above sample measurement apparatus, the measurement unit may perform standardization processing on the Raman spectrum, and may perform analysis of the sample based on the Raman spectrum after the standardization processing. Further, the measurement unit may extract a feature of the Raman spectrum, and may perform analysis of the sample based on the feature.

The sample measurement method according to the above embodiment is a sample measurement method for analyzing a sample by using Raman spectroscopy, and includes an irradiation step of irradiating the sample with excitation light output from a light source; and a measurement step of receiving Raman scattered light generated in the sample in response to irradiation of the excitation light, and acquiring a Raman spectrum, and in the irradiation step, an excitation light irradiation position is scanned along a line which does not pass through a same position on the sample a plurality of times over a period in which one Raman spectrum is acquired in the measurement step.

In the above sample measurement method, in the irradiation step, the excitation light irradiation position may be scanned along the line having a straight line shape. Further, in the irradiation step, the excitation light irradiation position may be scanned along the line at a constant speed.

In the above sample measurement method, in the irradiation step, the excitation light irradiation position may be scanned along each of a plurality of lines, and each line does not pass through the same position on the sample a plurality of times, and in the measurement step, the one Raman spectrum may be acquired for each of the plurality of lines.

In the above sample measurement method, in the irradiation step, the excitation light irradiation position may be scanned such that it does not pass through the same position on the sample in scanning of the excitation light irradiation position along the plurality of lines on the sample. Further, in the irradiation step, the excitation light irradiation position may be scanned such that excitation light irradiation regions on the sample in scanning of the excitation light irradiation position along the plurality of lines on the sample do not overlap each other.

In the above sample measurement method, in the measurement step, standardization processing may be performed on the Raman spectrum, and analysis of the sample may be performed based on the Raman spectrum after the standardization processing. Further, in the measurement step, a feature of the Raman spectrum may be extracted, and analysis of the sample may be performed based on the feature.

### Industrial Applicability

The present invention can be used as a sample measurement apparatus and a sample measurement method capable of easily performing quantitative analysis by using Raman spectroscopy in a measurement range on a sample.

### Reference Signs List

1, 2—sample measurement apparatus, 11—light source, 12—dichroic mirror, 13—lens, 14—filter, 15—lens, 16—spectrometer, 17—analysis unit, 21—stage, 22—scanning unit, 30—sample, 31—measurement range, 32—scanning line, 33—excitation light irradiation region.

1: A sample measurement apparatus for analyzing a sample by using Raman spectroscopy, the sample measurement apparatus comprising:
an irradiation unit configured to irradiate the sample with excitation light output from a light source; and
a measurement unit configured to receive Raman scattered light generated in the sample in response to irradiation of the excitation light, and acquire a Raman spectrum, wherein
the irradiation unit is configured to scan an excitation light irradiation position along a line which does not pass through a same position on the sample a plurality of times over a period in which the measurement unit acquires one Raman spectrum.

2: The sample measurement apparatus according to Claim 1, wherein the irradiation unit is configured to scan the excitation light irradiation position along the line having a straight line shape.

3: The sample measurement apparatus according to claim 1, wherein the irradiation unit is configured to scan the excitation light irradiation position along the line at a constant speed.

4: The sample measurement apparatus according to claim 1, wherein
the irradiation unit is configured to scan the excitation light irradiation position along each of a plurality of lines, and each line does not pass through the same position on the sample a plurality of times, and
the measurement unit is configured to acquire the one Raman spectrum for each of the plurality of lines.

5: The sample measurement apparatus according to claim 4, wherein the irradiation unit is configured to scan the excitation light irradiation position such that it does not pass through the same position on the sample in scanning of the excitation light irradiation position along the plurality of lines on the sample.

6: The sample measurement apparatus according to claim 5, wherein the irradiation unit is configured to scan the excitation light irradiation position such that excitation light irradiation regions on the sample in scanning of the excitation light irradiation position along the plurality of lines on the sample do not overlap each other.

7: The sample measurement apparatus according to claim 1, wherein the measurement unit is configured to perform standardization processing on the Raman spectrum, and perform analysis of the sample based on the Raman spectrum after the standardization processing.

8: The sample measurement apparatus according to claim 1, wherein the measurement unit is configured to extract a feature of the Raman spectrum, and perform analysis of the sample based on the feature.

9: A sample measurement method for analyzing a sample by using Raman spectroscopy, the sample measurement method comprising:
an irradiation step of irradiating the sample with excitation light output from a light source; and
a measurement step of receiving Raman scattered light generated in the sample in response to irradiation of the excitation light, and acquiring a Raman spectrum, wherein
in the irradiation step, an excitation light irradiation position is scanned along a line which does not pass through a same position on the sample a plurality of times over a period in which one Raman spectrum is acquired in the measurement step.

10: The sample measurement method according to claim 9, wherein in the irradiation step, the excitation light irradiation position is scanned along the line having a straight line shape.

11: The sample measurement method according to claim 9, wherein in the irradiation step, the excitation light irradiation position is scanned along the line at a constant speed.

12: The sample measurement method according to claim 9, wherein
in the irradiation step, the excitation light irradiation position is scanned along each of a plurality of lines, and each line does not pass through the same position on the sample a plurality of times, and
in the measurement step, the one Raman spectrum is acquired for each of the plurality of lines.

13: The sample measurement method according to claim 12, wherein in the irradiation step, the excitation light irradiation position is scanned such that it does not pass through the same position on the sample in scanning of the excitation light irradiation position along the plurality of lines on the sample.

14: The sample measurement method according to claim 13, wherein in the irradiation step, the excitation light irradiation position is scanned such that excitation light irradiation regions on the sample in scanning of the excitation light irradiation position along the plurality of lines on the sample do not overlap each other.

15: The sample measurement method according to claim 9, wherein in the measurement step, standardization processing is performed on the Raman spectrum, and analysis of the sample is performed based on the Raman spectrum after the standardization processing.

16: The sample measurement method according to claim 9, wherein in the measurement step, a feature of the Raman spectrum is extracted, and analysis of the sample is performed based on the feature.
